(19) United States
(12) Patent Application Publication
(10) Pub. No.: US 2015/0351144 A1
(43) Pub. Date: Dec. 3, 2015

(54) WIRELESS TRANSMISSION APPARATUS AND IMPLEMENTATION METHOD THEREOF

(71) Applicant: THLight Co., Ltd., Taipei City (TW)

(72) Inventors: Cheng-Jan CHI, Kaohsiung City (TW); Cho-Fu CHANG, New Taipei City (TW); Yu-Sheng WU, New Taipei City (TW); Tzu-Ho HUANG, Kaohsiung City (TW); Cheng-Wei LIN, Nantou County (TW); Cheng-Yu SHIH, New Taipei City (TW); Chin-Nan HUANG, New Taipei City (TW); Nien-An LAI, Taichung City (TW)

(21) Appl. No.: 14/725,282

(22) Filed: May 29, 2015

(30) Foreign Application Priority Data
Jun. 3, 2014 (TW) 103119290

(51) Int. Cl. H04W 76/02; H04W 72/04; H04W 4/00

(52) U.S. Cl. CPC H04W 76/023; H04W 4/008; H04W 72/0406

(57) ABSTRACT

A wireless transmission device and an implementation method thereof, wherein the wireless transmission device is plugged and connected to a host device for receiving a control signal transmitted from an electronic device (such as a mobile phone or a tablet PC), and the wireless transmission device is formed by a central processing module, a storage module, a Bluetooth transmission module and a transmission connector. The central processing module is electrically connected to the storage module, the Bluetooth transmission module and the transmission connector for converting the control signal received by the Bluetooth transmission module into a control instruction, and the transmission connector transmits the control instruction to the host device, and the electronic data stored in the storage module may be transmitted to the host device through the transmission connector and displayed on a display screen connected to the host device.

### BACKGROUND OF THE INVENTION

(a) Field of the Invention

The present invention relates to a wireless transmission device and its implementation method, and more particularly to the wireless transmission device and its implementation method having a built-in storage unit for storing electronic data and a Bluetooth transmission module for receiving a control signal transmitted from a mobile device to control a host device.

(b) Description of the Related Art

As science and technology advance, Smartphone gradually replaces traditional mobile phone. The Smartphone is capable of integrating multimedia, email, and networking functions. In addition, users may operate a host device such as a personal computer through the Smartphone. In the prior art, if a user wants to control a host device through the Smartphone, the user needs to send a control instruction via a wireless fidelity (WiFi) base station in order to control the host device via the Internet. In the conventional method, the control instruction transmitted from the Smartphone has to be transmitted via the WiFi base station before it is sent to the host device, thus not only just being limited by the WiFi base station that controls the online transmission speed, but also requiring a complicated configuration of the Smartphone and the host device. With reference to FIG. 1 for a conventional wireless transmission device 10, the conventional wireless transmission device 10 is informatively coupled to a control signal transmitter 11, and the information connection is completed after the wireless transmission device 10 is plugged and connected to a transmission interface 121 of a host device 12, so that the host device 12 may recognize the control signal transmitter 11 as a human interface device (HID) through the wireless transmission device 10 and transmit the control signal to the host device 12 through a control and an online transmission to control the operation of the host device 12. However, the wireless transmission device 10 sold in the market is generally bundled with the control signal transmitter 11 as a set (such as a presentation equipment set). In other words, if the wireless transmission device 10 breaks down, then the control signal transmitter 11 will be unable to be used with other wireless transmission devices 10, thus resulting in unnecessary waste. As disclosed in R.O.C. Utility Model No. 320258 entitled “Integrated apparatus of Bluetooth module and external storage medium access module”, the integrated device may be informatively coupled to an electronic device with the Bluetooth transmission function, but the data of the electronic device can just be transmitted to a host device or an external storage medium access module only, so the electronic device cannot conduct an operation of the host device according to the control instruction.

### SUMMARY OF THE INVENTION

Therefore, it is a primary objective of the present invention to provide a wireless transmission device and its implementation method capable of storing electronic data and using an electronic device to transmit a control signal for controlling a built-in storage unit operated by a host device.

To achieve the aforementioned objective, the present invention provides a wireless transmission device comprising a central processing module, a storage module, a Bluetooth transmission module and a transmission connector, wherein the wireless transmission device is plugged and connected to a transmission interface of a host device through the transmission connector for information connection, and the Bluetooth transmission module may be informatively coupled to an electronic device, so that the host device can recognize the wireless transmission device as a human interface device (HID). When the wireless transmission device receives a control signal transmitted from the electronic device through the Bluetooth transmission module, the wireless transmission device converts the control signal into a control instruction by the central processing module and further transmits the control instruction to the host device through a transmission interface of the host device in order to control the operation of the host device by electronic device. After the wireless transmission device and the host device are informatively coupled, the electronic data stored in the storage module may be displayed on a display screen connected to the host device by an operation, so that the electronic device may perform an electronic operation such as a presentation by the present invention.

### BRIEF DESCRIPTION OF THE FIGURES

FIG. 1 shows a conventional wireless transmission device;

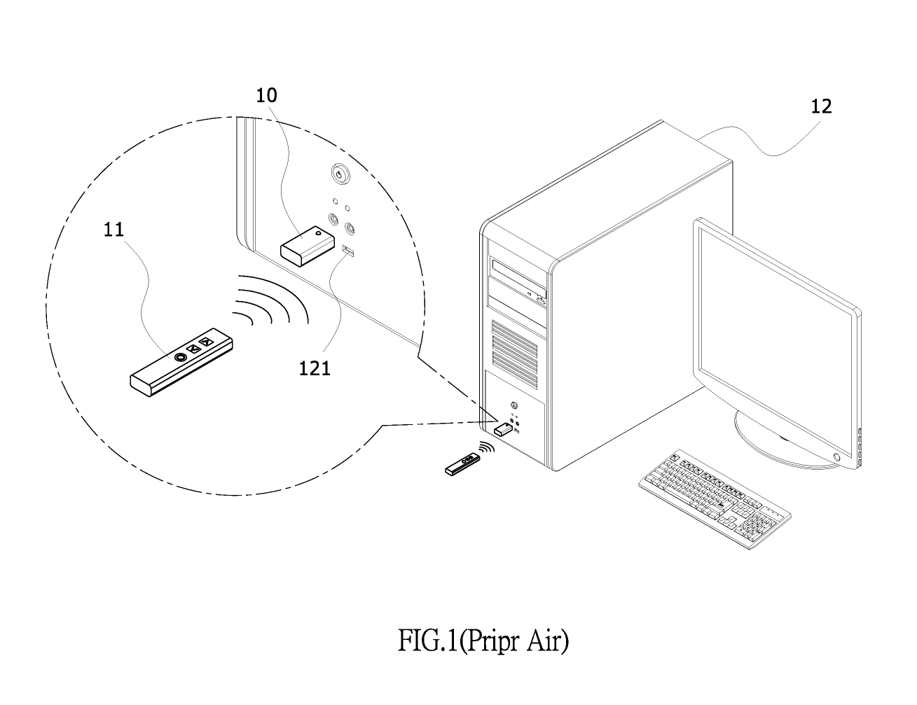

FIG. 2 is a schematic block diagram of a wireless transmission device of the present invention;

FIG. 3 is a first schematic view of the implementation of the present invention;

FIG. 4 is a second schematic view of the implementation of the present invention;

FIG. 5 is a third schematic view of the implementation of the present invention;

FIG. 6 is a fourth schematic view of the implementation of the present invention; and

FIG. 7 is a flow chart of an implementation method of the present invention.

### DETAILED DESCRIPTION OF THE PREFERRED EMBODIMENT

The technical measures and characteristics of the present invention will become clearer in light of the following detailed description of an illustrative embodiment of this invention described in connection with the drawings.

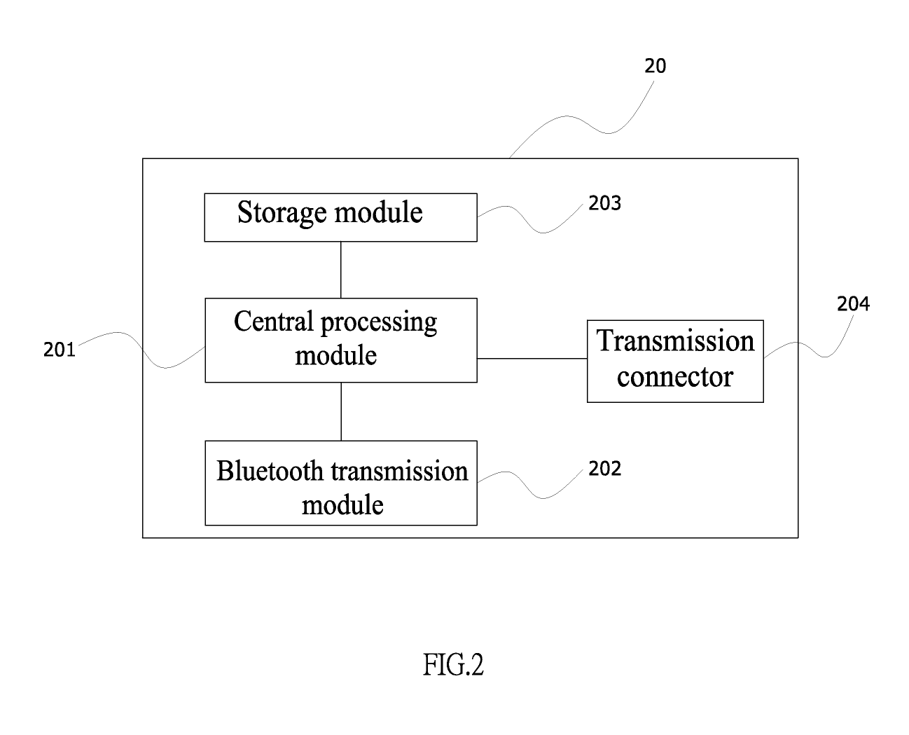

With reference to FIG. 2 for a wireless transmission device 20 of the present invention, the wireless transmission device 20 comprises a central processing module 201, a Bluetooth transmission module 202, a storage module 203 and a transmission connector 204, wherein the central processing module 201 is informatively coupled to the Bluetooth transmission module 202, the storage module 203 and the transmission connector 204, and the central processing module 201 may be a micro-controller, a microprocessor, or a central processing unit, and the Bluetooth transmission module 202 may be coupled to an electronic device 21 having a Bluetooth module such as a mobile phone or a tablet PC via wireless connection, and the storage module 203 is provided for storing and reading electronic data, and the transmission connector 204 may be a Universal Serial Bus 2.0, Universal Serial Bus 3.0, Thunderbolt, Micro Universal Serial Bus, or High Definition Multimedia Interface connector. Therefore, the wireless transmission device 20 of the present invention may be plugged and connected to a host device 12 through a transmission connector 104 for information connection.

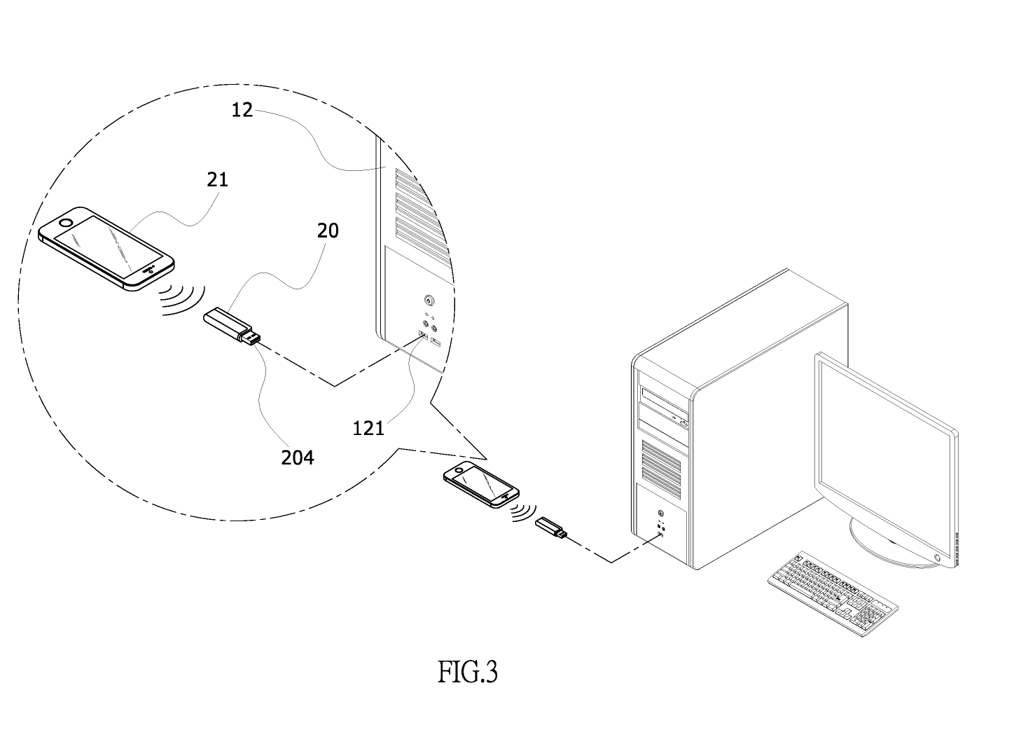

With reference to FIG. 3 in conjunction with FIG. 2 for the implementation of the present invention, the transmission connector 204 is plugged into the transmission interface 121 of the host device 12, so that the wireless transmission device 20 and the host device 12 are informatively coupled to each other. After the wireless transmission device 20 and the host device 12 are informatively coupled to each other, the wireless transmission device 20 is recognized as a human interface device (HID) by the host device 12, and the electronic device 21 having the Bluetooth module may be informatively coupled to the Bluetooth transmission module 202 of the wireless transmission device 20 via Bluetooth connection, and the Bluetooth connection may be established by Bluetooth 3.0, Bluetooth 4.0 (or Bluetooth low energy), Bluetooth LE or any other Bluetooth technology, but the present invention is not limited to the above. After the wireless transmission device 20 and the electronic device 21 are informatively coupled to each other via the Bluetooth connection, the Bluetooth transmission module 202 can receive the control signal transmitted from the electronic device 21.

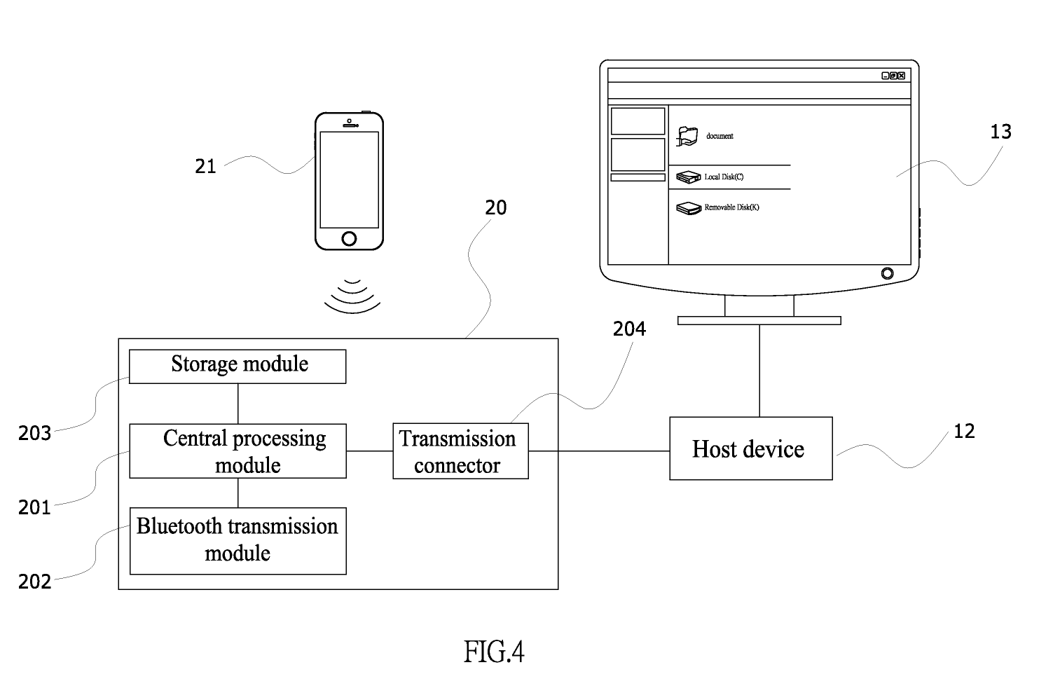

In FIG. 4, after the wireless transmission device 20 and the host device 12 are informatively coupled to each other, the operating system of the host device 11 will create a corresponding device descriptor, so that the operating system of the host device 12 can recognize the wireless transmission device 20 as a human interface device (HID), and the host device 12 may read the electronic data stored in the storage module 203 through the central processing module 201 with the transmission connector 204 of the wireless transmission device 20 and display the electronic data on a display screen 13 connected to the host device 12 or store the electronic data into the storage module 203. Therefore, the wireless transmission device 20 of the present invention after being plugged and informatively coupled to the host device 12 may be used as an external storage device.

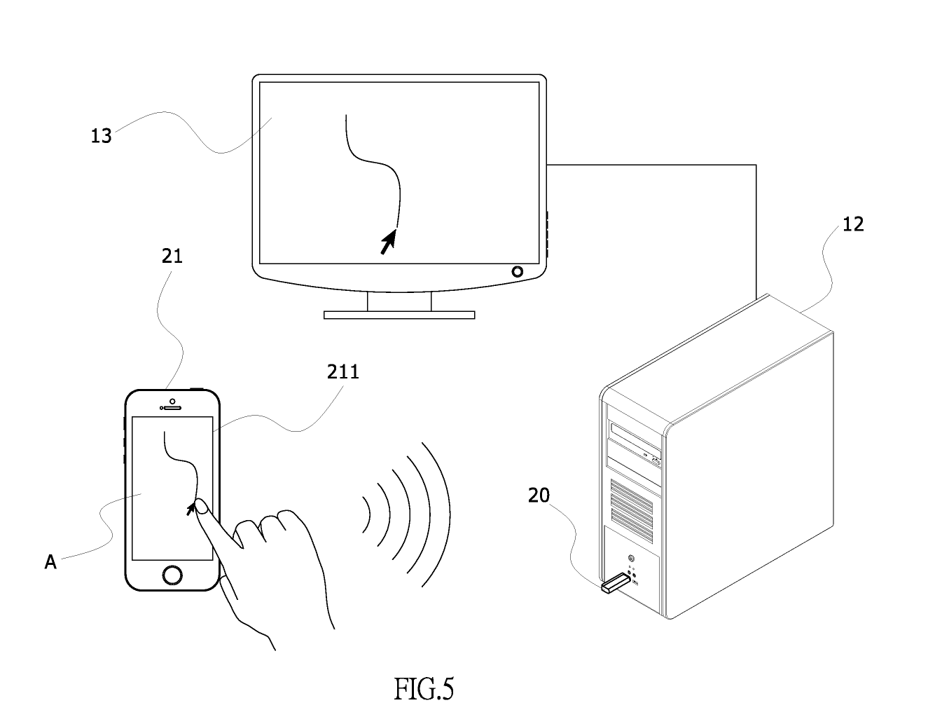

With reference to FIG. 5 in conjunction with FIGS. 2 and FIG. 3 for a preferred embodiment of the present invention, the electronic device 21 includes a pre-installed control application program and creates a control online connection through the Bluetooth transmission interface and the Bluetooth transmission module 202 of the wireless transmission device 20, and the control application program displays an operation interface A on a screen 211 of the electronic device 21, so that the control application program generates a control signal according to a user's operation on the operation interface A and transmits the control signal to the wireless transmission device 20 through the control online connection. After the wireless transmission device 20 establishes the control online connection with the electronic device 21 through the Bluetooth transmission interface, the wireless transmission device 20 can control the operation of the host device 12 according to the operation interface A on the electronic device 21 displayed by control application program. For example, if the control application program provides a cursor operation interface on a screen 211 of the electronic device 21, the control application program will transmit a corresponding control signal to the wireless transmission device 20, such that when a user moves his/her finger on the operation interface A displayed on the electronic device 21, the control application program generates a corresponding cursor control signal and transmits the cursor control signal to the wireless transmission device 20, and when the central processing module 201 of the wireless transmission device 20 receives the cursor control signal through the Bluetooth transmission module 202, the central processing module 201 converts the cursor control signal into a cursor control instruction and transmits the cursor control instruction to the transmission connector 204. At that time, the transmission connector 204 transmits the cursor control instruction to the host device 12 through the transmission interface 121, and the operating system of the host device 12 makes the movement of a cursor on the display screen 13 of the host device 12 according to the control instruction. Therefore, the user simply needs to move his/her finger on the screen 211 of the electronic device 21 to control the movement of the cursor displayed on the display screen 13 connected to the host device 12.

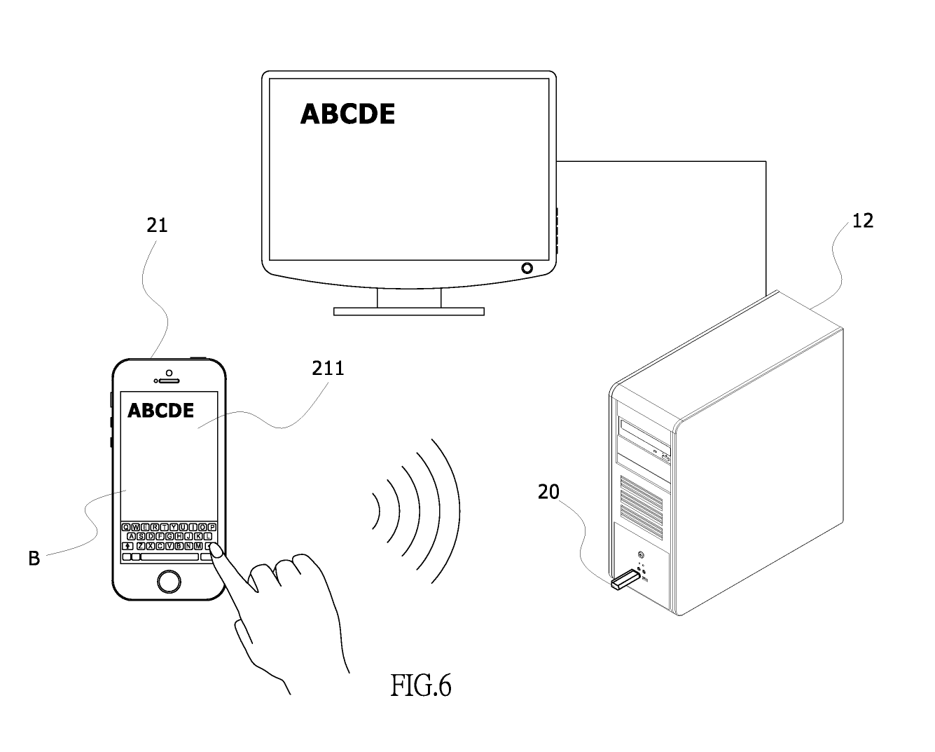

With reference to FIG. 6 in conjunction with FIGS. 2 and 3, the control application program displays an operation interface B on the screen 211 of the electronic device 21 according to the user's requirement, and the operation interface B may be a virtual keyboard interface, a multimedia operation interface, or a presentation operation interface (wherein this preferred embodiment uses the virtual keyboard interface to illustrate the invention). At that time, the host device 12 will recognize the electronic device 21 as a keyboard according to the device descriptor created by the operating system of the wireless transmission device 20. When a user presses a virtual key on the virtual keyboard interface, the control application program generates a corresponding character input signal. When the central processing module 201 receives the character input signal, the central processing module converts the character input signal into a keyboard control instruction and input the keyboard control instruction to the host device 12 from the transmission interface 121 to facilitate the transmission of the character inputted by the user to the operating system of the host device 12. Therefore, the user may input a character to the host device 12 by operating the virtual keyboard interface displayed on the screen 211.

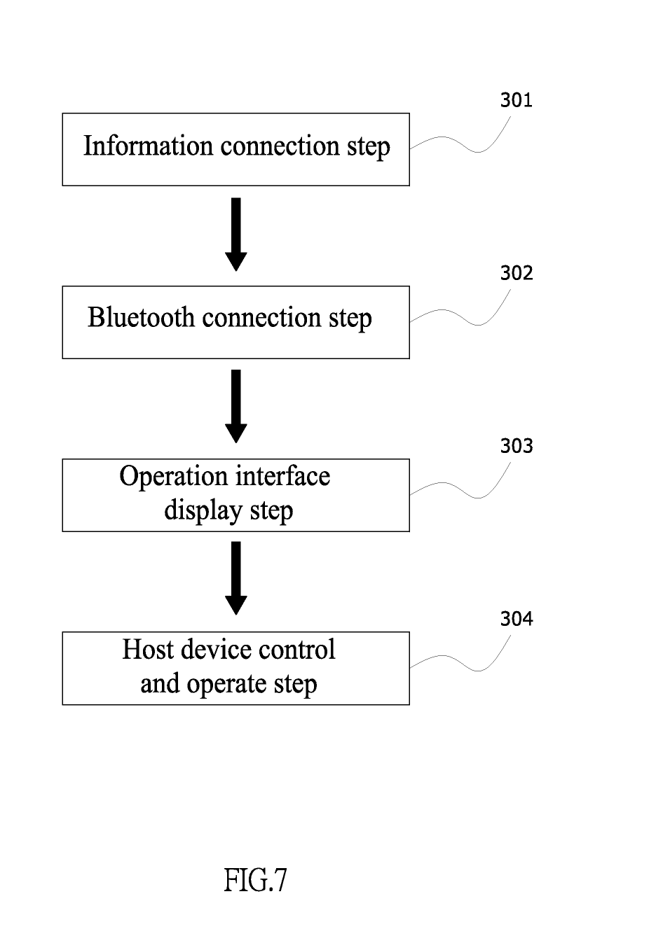

With reference to FIG. 7 for the implementation method of the present invention, the implementation method comprises the following steps:

An information connection step (301): Informatively connect a wireless transmission device 20 to a host device 12 after plugging and connecting a transmission connector 204 of the wireless transmission device 20 to a transmission interface 121 of a host device 12, then an operating system of the host device 12 will create a corresponding device descriptor, so the operating system of the host device 12 can recognize the wireless transmission device 20 as a human interface device (HID), and the wireless transmission device 20 also may be recognized by the host device 12 as an external storage device, and the host device 12 can read the electronic data stored in a storage module 203 of the wireless transmission device 20.

A Bluetooth connection step (302): Pre-install a control application program into the electronic device 21, and create a control online connection through a Bluetooth transmission interface and a Bluetooth transmission module 202 of the wireless transmission device 20.

An operation interface display step (303): Display an operation interface on a screen 211 of the electronic device 21 by the control application program, and generate a control signal by the control application program according to the user's operation on the operation interface, and transmit the control signal to the wireless transmission device 20 through a control online connection.

A host device control and operate step (304): When users operate the operation interface displayed on the screen 211 of the electronic device 21, and it will control the host device 12 to produce a corresponding operation.

In summation of the description above, the host device may read electronic data from the storage module of the wireless transmission device or store the electronic data into the storage module of the wireless transmission device after the wireless transmission device and the host device are informatively coupled to each other, and the wireless transmission device can receives a control signal transmitted from the electronic device after the wireless information connection between the Bluetooth transmission interface and the electronic device is completed, so that the central processing module can converts the control signal into a control instruction and transmits the control instruction to the host device through the transmission connector to control the host device. With the implementation of the present invention, the wireless transmission device and its implementation method can achieve the effects of storing electronic data and using an electronic device to transmit a control signal to control the built-in storage unit operated by the host device.

Many changes and modifications in the above-described embodiments of the invention can, of course, be carried out without departing from the scope thereof Accordingly, to promote the progress in science and the useful arts, the invention is disclosed and is intended to be limited only by the scope of the appended claims.

What is claimed is:

1. A wireless transmission device, comprising:
a central processing module, for converting a control signal into a control instruction;
a Bluetooth transmission module, informatively coupled to the central processing module, for receiving the control signal transmitted from an electronic device, after the electronic device completes a wireless connection;
a storage module, informatively coupled to the central processing module, for storing electronic data; and
a transmission connector, informatively coupled to the central processing module, and plugged into a transmission interface of a host device, such that the wireless transmission device is informatively coupled to the host device.

2. An implementation method of a wireless transmission device, comprising:
an information connection step for informatively connecting the wireless transmission device to a host device through a transmission connector after the host device is plugged and installed to a transmission interface, and creating a corresponding device descriptor in an operating system of the host device, so that the operating system of the host device is able to recognize the wireless transmission device as a peripheral device, and a storage module of the wireless transmission device is provided for the host device to store and read electronic data;
a Bluetooth connection step for pre-installing a control application program to an electronic device, and creating a control online connection between a Bluetooth transmission interface and a Bluetooth transmission module of the wireless transmission device, so that the electronic device and the wireless transmission device are informatively coupled to each other;
an operation interface display step for displaying an operation interface on a screen of the electronic device, generating a control signal after a user operates the operation interface, transmitting the control signal to the wireless transmission device through the control online connection, and converting the control signal into a control instruction by a central processing module of the wireless transmission device; and
a host control operation step for controlling the host device to produce a corresponding operation through the wireless transmission device after the control instruction is transmitted to the host device.

3. The implementation method as claimed in claim 2, wherein the operation interface is a cursor operation interface.

4. The implementation method as claimed in claim 2, wherein the operation interface is a virtual keyboard interface.

5. The implementation method as claimed in claim 2, wherein if the control signal is a cursor control signal, the control signal will be converted into a mouse control instruction for controlling the movement of a cursor on a display screen connected to the host device.

6. The implementation method as claimed in claim 2, wherein if the control signal is a character input signal, the control signal will be converted into a keyboard control instruction for inputting a character into the host device.
